(19) United States
(12) Patent Application Publication
(10) Pub. No.: US 2013/0080221 A1
(43) Pub. Date: Mar. 28, 2013

(54) DIGITAL SIGNAGE SYSTEM AND INTERACTIVE METHOD PERFORMED THEREBY

(71) Applicants: Yung-Chu Lin, Hsinchu County (TW); Yun-Chang Wang, Hsinchu County (TW); Wen-Hsien Chiu, Changhua County (TW)

(72) Inventors: Yung-Chu Lin, Hsinchu County (TW); Yun-Chang Wang, Hsinchu County (TW); Wen-Hsien Chiu, Changhua County (TW)

(21) Appl. No.: 13/614,504

(22) Filed: Sep. 13, 2012

(30) Foreign Application Priority Data
Sep. 28, 2011 (TW) 100134980

(51) Int. Cl. G06Q 30/02

(52) U.S. Cl. 705/14.4

(57) ABSTRACT

An interactive method to be performed by a digital signage for interaction with a portable electronic device includes configuring the digital signage to establish a wireless communication link with the portable electronic device, to generate playback signals associated with advertisement contents stored in the digital signage, to transmit the playback signals to the portable electronic device, wherein the playback signals enable the portable electronic device to display the advertisement contents and to enable transmission of a corresponding select signal to the digital signage in response to user operation associated with a selected displayed one of the advertisement contents, and to process the select signal.

### CROSS-REFERENCE TO RELATED APPLICATION

This application claims priority of Taiwanese Patent Application No. 100134980, filed on Sep. 28, 2011.

### BACKGROUND OF THE INVENTION

1. Field of the Invention

The present invention relates to a digital signage, more particularly to a digital signage system provided with an interactive function.

2. Description of the Related Art

A digital signage usually has higher advertising effectiveness compared to traditional print advertising via print media. However, a conventional digital signage simply displays advertisement videos or pictures, and is incapable of interacting with consumers.

If a touch screen is included in the digital signage for providing an interactive function to the consumers, a cost of the digital signage will rise and the consumers are not necessarily willing to utilize the interactive function in public. Furthermore, the digital signage with the touch screen may merely enable a small number of consumers to interact with an advertisement that is being displayed by the digital signage at the same time.

### SUMMARY OF THE INVENTION

Therefore, an object of the present invention is to provide an interactive method to be performed by a digital signage for alleviating the aforementioned drawbacks of the conventional digital signage.

Accordingly, the interactive method of the present invention is to be performed by a digital signage for interaction with a portable electronic device, and comprises the steps of:

(A) after a wireless communication link is established between the digital signage and the portable electronic device, configuring the digital signage to generate playback signals associated respectively with advertisement contents of advertisement objects stored in the digital signage and to transmit the playback signals to the portable electronic device, wherein the playback signals enable the portable electronic device to display the advertisement contents on a user interface thereof and to enable transmission by the portable electronic device of a corresponding select signal to the digital signage in response to user operation associated with a selected displayed one of the advertisement contents; and

(B) configuring the digital signage to process the select signal from the portable electronic device.

Another object of the present invention is to provide a digital signage system capable of alleviating the aforementioned drawbacks of the conventional digital signage.

Accordingly, the digital signage system of the present invention comprises a digital signage for interaction with a portable electronic device. The digital signage includes a communication module, a memory, and a processor. The communication module is configured to establish a wireless communication link with the portable electronic device. The memory is configured to store advertisement contents of advertisement objects. The processor is coupled electrically to the communication module and the memory. The processor is configured to generate playback signals associated respectively with the advertisement contents of the advertisement objects, and to transmit the playback signals to the portable electronic device via the communication module. The playback signals enable the portable electronic device to display the advertisement contents on a user interface thereof and to enable transmission by the portable electronic device of a corresponding select signal to the digital signage in response to user operation associated with a selected displayed one of the advertisement contents. The processor is further configured to process the select signal from the portable electronic device.

An effect of the present invention resides in that, by virtue of the wireless communication link established between the digital signage and the portable electronic device, the digital signage may enable the portable electronic device to di splay the advertisement contents regardless of which one of the advertisement contents is currently being displayed by the digital signage. Moreover, the digital signage may provide interactive functions to multiple portable electronic devices at the same time so as to extend advertising time and promote advertising effectiveness.

### BRIEF DESCRIPTION OF THE DRAWINGS

Other features and advantages of the present invention will become apparent in the following detailed description of a preferred embodiment with reference to the accompanying drawings, of which:

FIG. 1 is a block diagram of a preferred embodiment of a digital signage system according to the present invention; and

FIG. 2 is a flow chart illustrating a preferred embodiment of an interactive method to be performed by the digital signage system according to the present invention.

### DETAILED DESCRIPTION OF THE PREFERRED EMBODIMENT

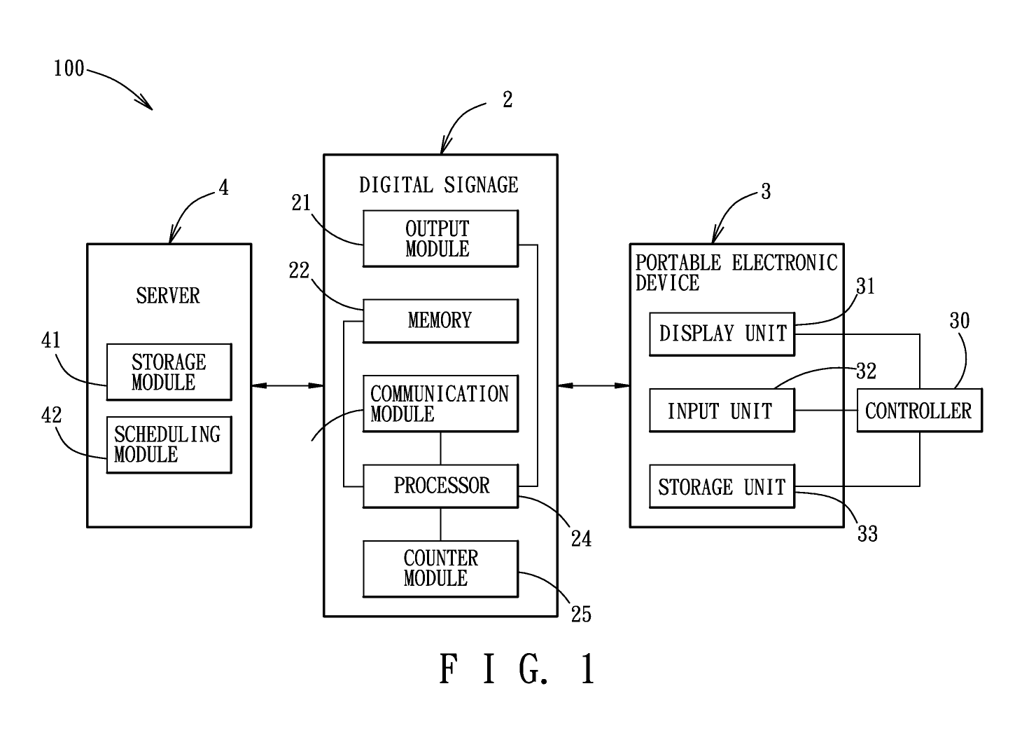

Referring to FIG. 1, a preferred embodiment of a digital signage system 100 according to the present invention comprises a digital signage 2 for interaction with a portable electronic device 3, such as one of an i-phone, an i-pad, a smart phone, a tablet, a laptop, etc. In practice, the number of the portable electronic device 3 is not limited to one.

The digital signage 2 includes an output module 21, a memory 22, a communication module 23, and a processor 24 that is coupled electrically to the output module 21, the memory 22 and the communication module 23. The memory 22 is configured to store advertisement contents of advertisement objects. The processor 24 is configured to control the output module 21 to output respectively the advertisement contents of the advertisement objects stored in the memory 22. In this embodiment, each of the advertisement objects is an advertisement program containing the respective advertisement content. The processor 24 is configured to execute each of the advertisement programs so as to control the output module 21 to display the corresponding advertisement contents. It is noted that, the formats of the advertisement objects are not limited to the disclosure in this embodiment. Preferably, the output module 21 is a liquid crystal display (LCD) screen.

It is noted that even though the output module 21 of the digital signage 2 in this embodiment is a LCD screen, the implementation of the output module 21 is not limited to the disclosure herein, and may be selected from one of a light-emitting diode (LED) screen, an organic light-emitting diode (OLED) screen, a LED digital signage and an E-paper display.

The communication module 23 is configured to establish a wireless communication link with the portable electronic device 3 via a communications protocol, such as one of wifi, NFC, WiMax, Wireless USB, Blue tooth, etc. Preferably, the communication module 23 is a wireless access point (WAP).

After the wireless communication link is established between the digital signage 2 and the portable electronic device 3, the processor 24 is further configured to generate playback signals associated respectively with the advertisement contents of the advertisement objects stored in the memory 22, and to transmit the playback signals to the portable electronic device 3 via the communication module 23. In this embodiment, the playback signals are generated signals attributed to execution of the advertisement programs by the processor 24.

The playback signals enable the portable electronic device 3 to display the advertisement contents on a graphical user interface thereof and to enable transmission by the portable electronic device 3 of a corresponding select signal to the digital signage 2 in response to user operation associated with a selected displayed one of the advertisement contents. Specifically, the electronic device 3 includes a display unit 31, an input unit 32, and a controller 30 coupled electrically to the display unit 31 and the input unit 32. The controller 30 reads the playback signals received from the digital signage 2, and controls the display unit 31 to display the user interface for viewing of the advertisement contents corresponding to the playback signals. The input unit 32 is utilized for input of the user operation so as to select one of the advertisement contents displayed on the user interface. In response to the user operation, the controller 30 transmits the select signal corresponding to the selected displayed one of the advertisement contents to the digital signage 2 via the communication module 23. In this embodiment, the display unit 31 of the portable electronic device 3 is a LCD screen, and the input unit 32 is a touch control module. Alternatively, the touch control module may be integrated with the LCD screen to form a touch screen that implements both the display unit 31 and the input unit 32.

After the digital signage 2 receives the select signal from the portable electronic device 3, the processor 24 of the digital signage 2 is further configured to process the select signal. In processing the select signal, the processor 24 generates a service signal corresponding to the select signal, and transmits the service signal to the portable electronic device 3. The service signal enables the portable electronic device 3 to display at least one service option on the user interface thereof and to enable transmission by the portable electronic device 3 of a corresponding service request signal to the digital signage 2 in response to user selection of the at least one service option displayed thereby. In this embodiment, the at least one service option includes an advertisement download option, a webpage link option and a contact option, and the user interface includes a first interactive interface for display of the service options. Further details associated with the service options will be explained in the following paragraphs. It is noted that since the service signal corresponds to the select signal, and since the select signal corresponds to the selected displayed one of the advertisement contents, each of the service options displayed on the user interface corresponds to the selected displayed one of the advertisement contents. Moreover, since the service request signal corresponds to a user-selected one of the service options, the service request signal in nature corresponds to the selected displayed one of the advertisement contents.

After the digital signage 2 receives the service request signal from the portable electronic device 3, the processor 24 is further configured to process the service request signal. In processing the service request signal, the processor 24 may enable the portable electronic device 3 to download information related to the service request signal. The information is stored in one of the digital signage 2 and a server 4 connected to the digital signage 2. For example, when the advertisement download option displayed on the first interactive interface is selected, the portable electronic device 3 transmits the service request signal corresponding to the advertisement download option to the digital signage 2, and the processor 24 enables the portable electronic device 3 to download the advertisement content corresponding to the selected displayed one of the advertisement contents from the digital signage 2 so that the portable electronic device 3 may display the advertisement content once again. In a similar manner, when the webpage link option is selected, the portable electronic device 3 transmits the service request signal corresponding to the webpage link option to the digital signage 2, and the processor 24 enables the portable electronic device 3 to open a web browser to navigate to a web page corresponding to the selected displayed one of the advertisement contents.

In another configuration of processing the service request signal, the processor 24 of the digital signage 2 may respond to the service request signal for enabling generation and transmission of a message using the portable electronic device 3 to a predetermined contact associated with the service request signal. For example, when the contact option is selected, the portable electronic device 3 transmits the service request signal corresponding to the contact option to the digital signage 2, and the processor 24 enables the portable electronic device 3 to generate a blank e-mail that contains a recipient address associated with the selected displayed one of the advertisement contents and that is to be filled up by the user of the portable electronic device 3 to result in the message that is subsequently sent to a mail server corresponding to the recipient address.

It is noted that, in the present invention, aside from interactive functions provided in the first interactive interface, more advanced interactive functions may be implemented by virtue of a design to be explained hereinafter.

Specifically, in this embodiment, the at least one service option further includes an interactive application download option displayed on the first interactive interface. The memory 22 of the digital signage 2 further stores an interactive application. The portable electronic device 3 further includes a storage unit 33. When the interactive application download option is selected, the portable electronic device 3 transmits the corresponding service request signal. The digital signage 2 enables the portable electronic device 3 to download the interactive application from the digital signage 2 and to store and install the interactive application in the storage unit of the portable electronic device 3. After installation of the interactive application, when the portable electronic device 3 displays the at least one service option on the first interactive interface, the at least one service option further includes an advanced interactive option displayed on the first interactive interface. In this embodiment, the at least one service option further includes a game option and a transaction option, and the user interface further includes a second interactive interface for display of the game option and the transaction option. When the advanced interactive option displayed on the first interactive interface is selected via the input unit 32, the portable electronic device 3 executes the interactive application so as to display the game option and the transaction option on the second interactive interface via the display unit 31. It is noted that since the game option and the transaction option are service options associated with user account login, the game option and the transaction option are only displayed after installation of the interactive application. When the game option is selected, the portable electronic device 3 runs game software that is played after user account login.

In yet another configuration of processing the service request signal, the processor 24 of the digital signage 2 enables a user using the portable electronic device 3 to conduct a purchase transaction related to the service request signal with a server. For example, when the service request signal corresponding to the transaction option is received from the portable electronic device 3, the processor 24 enables the portable electronic device 3 to generate a transaction order and to transmit the transaction order to the server associated with the selected displayed one of the advertisement contents. It is noted that the transaction order includes information related to a user account, and authentication management of the user account is implemented by means of the interactive application.

In this embodiment, the digital signage system 100 according to the present invention further comprises a server 4 connected to the digital signage 2. The server 4 includes a storage module 41, which stores a plurality of to-be-played advertisement objects and a scheduling program, and a scheduling module 42, which is configured to execute the scheduling program for automatically transmitting the to-be-played advertisement objects to the digital signage 2 such that the to-be-played advertisement objects are stored as the advertisement objects in the memory 22 of the digital signage 2. Moreover, in this embodiment, since each of the advertisement contents is di splayed by the output module 21 of the digital signage 2 for a predetermined fixed time, when display of one of the advertisement contents of the advertisement objects ends, the digital signage 2 receives the to-be-played advertisement objects transmitted from the scheduling module 42 of the server 4 for display.

In addition, clients may desire to have information on how many users have interacted with advertisement of the digital signage 2. Therefore, the digital signage further includes a counter module 25 coupled electrically to the processor 24. The counter module 25 is configured to count and record, for each of the advertisement contents, a number of times of selection based on the select signal received by the digital signage 2. Specifically, when one of the displayed advertisement contents is selected via the input unit 32 of the portable electronic device 3, the controller 30 transmits the corresponding select signal to the digital signage 2. The counter module 25 of the digital signage 2 counts and records the number of times of selection related to the selected displayed one of the advertisement contents based on the select signal. Subsequently, the number of times of selection recorded thereby is transmitted to the server 4 for storage in the storage module 41, such that the clients may have information on effectiveness of their advertisement contents in attracting customer attention.

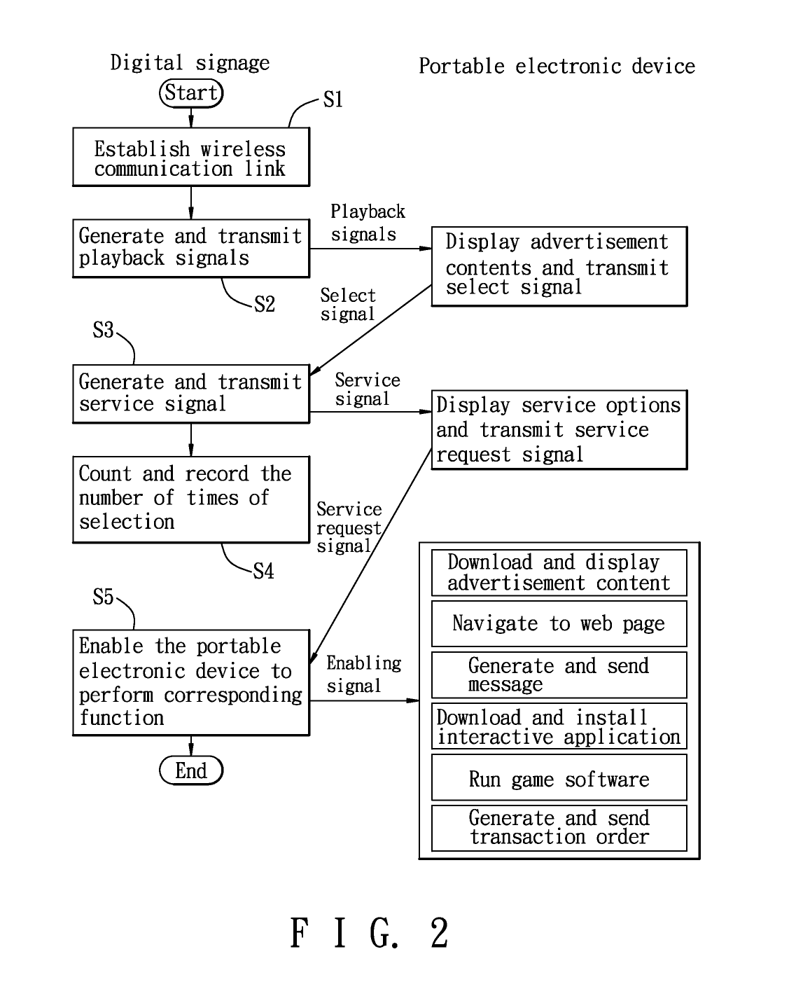

Referring to FIG. 1 and FIG. 2, a preferred embodiment of an interactive method to be performed by the digital signage system 100 according to the present invention is illustrated.

When the portable electronic device 3 is moved to be within an area of coverage of the communication module 23 of the digital signage 2, in step S1, the digital signage 2 is configured to establish a wireless communication link with the portable electronic device 3.

In step S2, the digital signage 2 is configured to generate the playback signals associated respectively with the advertisement contents of the advertisement objects, and to transmit the playback signals to the portable electronic device 3. Upon receipt of the playback signals, the portable electronic device 3 is enabled to display the advertisement contents on the user interface, and to transmit the corresponding select signal to be digital signage 2 in response to the user operation. The user operation is performed by the user for selecting one of the advertisement contents displayed on the user interface. In this embodiment, prior to display of the advertisement contents, the portable electronic device 3 is enabled by the digital signage 2 to determine whether the interactive application has been installed, and to display two options of first and second interactive modes to be selected when it is determined that the interactive application has been installed. Further details of the first and second interactive modes will be explained in the following paragraphs.

In step S3, upon receipt of the select signal, the digital signage 2 generates the service signal corresponding to the select signal and transmits the service signal to the portable electronic device 3. Upon receipt of the service signal, the portable electronic device 3 is enabled to display the at least one service option on the user interface thereof, and to transmit the corresponding service request signal to the digital signage 2 in response to user selection of the at least one service option displayed thereby. In this embodiment, when it is determined by the portable electronic device 3 that the interactive application has not been installed, the portable electronic device 3 displays the advertisement download option, the webpage link option, the contact option and the interactive application download option on the first interactive interface. Alternatively, when the first interactive mode is selected previously, it is the advertisement download option, the webpage link option, the contact option and the advanced interactive option that are displayed on the first interactive interface. Otherwise, when the second interactive mode is selected previously, it is the game option and the transaction option that are displayed on the second interactive interface.

In step S4, for each of the advertisement objects, the digital signage 2 counts and records the number of times of the selection based on the select signal received thereby.

In step S5, upon receipt of the service request signal, the digital signage 2 enables the portable electronic device 3 to perform a corresponding function, such as download the corresponding advertisement content and display the same, navigate to the web page corresponding to the advertisement content, generate and send a message to the predetermined contact, download and install the interactive application, run game software to be played, or generate and send the transaction order.

To sum up, the digital signage system 100 of the present invention, by means of the digital signage 2 in communication with at least one portable electronic device 3, may interact with multiple portable electronic devices 3 at the same time without limitation of display time and display sequence of the advertisement contents, so as to achieve an effect of extending the advertising time. Further, by means of enabling installation of the interactive application in the portable electronic device 3, advanced interactive functions, such as purchase transaction and game playing, may be provided so as to further promote effectiveness of advertising.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An interactive method to be performed by a digital signage for interaction with a portable electronic device, the interactive method comprising the steps of:
(A) after a wireless communication link is established between the digital signage and the portable electronic device, configuring the digital signage to generate playback signals associated respectively with advertisement contents of advertisement objects stored in the digital signage and to transmit the playback signals to the portable electronic device, wherein the playback signals enable the portable electronic device to display the advertisement contents on a user interface thereof and to enable transmission by the portable electronic device of a corresponding select signal to the digital signage in response to user operation associated with a selected displayed one of the advertisement contents; and
(B) configuring the digital signage to process the select signal from the portable electronic device.

2. The interactive method as claimed in claim 1, wherein step (B) includes:
(B1) configuring the digital signage to generate a service signal corresponding to the select signal and to transmit the service signal to the portable electronic device, wherein the service signal enables the portable electronic device to display at least one service option on the user interface thereof and to enable transmission by the portable electronic device of a corresponding service request signal to the digital signage in response to user selection of the at least one service option displayed thereby; and
(B2) configuring the digital signage to process the service request signal from the portable electronic device.

3. The interactive method as claimed in claim 2, wherein step (B2) includes:
configuring the digital signage to enable the portable electronic device to download information related to the service request signal, the information being stored in one of the digital signage and a server connected to the digital signage.

4. The interactive method as claimed in claim 2, wherein, in step (B2), the digital signage is configured to respond to the service request signal for enabling generation and transmission of a message using the portable electronic device to a predetermined contact associated with the service request signal.

5. The interactive method as claimed in claim 2, wherein step (B2) includes:
configuring the digital signage to enable a user using the portable electronic device to conduct a purchase transaction, that is related to the service request signal, with a server.

6. The interactive method as claimed in claim 1, further comprising the step of:
configuring the digital signage to count and record, for each of the advertisement objects, a number of times of selection based on the select signal received thereby.

7. A digital signage system comprising a digital signage for interaction with a portable electronic device, said digital signage including:
a communication module configured to establish a wireless communication link with the portable electronic device;
a memory configured to store advertisement contents of advertisement objects; and
a processor coupled electrically to said communication module and said memory, and configured to
generate playback signals associated respectively with the advertisement contents of the advertisement objects,
transmit the playback signals to the portable electronic device via said communication module, wherein the playback signals enable the portable electronic device to display the advertisement contents on a user interface thereof and to enable transmission by the portable electronic device of a corresponding select signal to said digital signage in response to user operation associated with a selected displayed one of the advertisement contents, and
process the select signal from the portable electronic device.

8. The digital signage system as claimed in claim 7, wherein in processing the select signal, said processor is further configured to:
generate a service signal corresponding to the select signal and to transmit the service signal to the portable electronic device, wherein the service signal enables the portable electronic device to display at least one service option on the user interface thereof and to enable transmission by the portable electronic device of a corresponding service request signal to said digital signage in response to user selection of the at least one service option displayed thereby; and
process the service request signal from the portable electronic device.

9. The digital signage system as claimed in claim 8, wherein, in processing the service request signal, said processor is further configured to enable the portable electronic device to download information related to the service request signal, the information being stored in one of said digital signage and a server connected to said digital signage.

10. The digital signage system as claimed in claim 8, wherein, in processing the service request signal, said processor is further configured to respond to the service request signal for enabling generation and transmission of a message using the portable electronic device to a predetermined contact associated with the service request signal.

11. The digital signage system as claimed in claim 8, wherein, in processing the service request signal, said processor is further configured to enable a user using the portable electronic device to conduct a purchase transaction, that is related to the service request signal, with a server.

12. The digital signage system as claimed in claim 7, wherein said digital signage further includes a counter module configured to count and record, for each of the advertisement objects, a number of times of selection based on the select signal received by said digital signage.

13. The digital signage system as claimed in claim 7, further comprising a server connected to said digital signage, said server including a storage module, which stores a plurality of to-be-played advertisement objects and a scheduling program, and a scheduling module, which is configured to execute said scheduling program for automatically transmitting said to-be-played advertisement objects to said digital signage such that said to-be-played advertisement objects are stored as the advertisement objects in said memory of said digital signage.

14. The digital signage system as claimed in claim 13, wherein said digital signage further includes a counter module configured to count and record, for each of the advertisement objects, a number of times of selection based on the select signal received by said digital signage, the number of times of selection recorded thereby being transmitted to said server for storage in said storage module.
